(19) United States
(12) Patent Application Publication
(10) Pub. No.: US 2025/0081002 A1
(43) Pub. Date: Mar. 6, 2025

(54) TRANSMITTING INFORMATION RELATED TO RADIO RESOURCE MANAGEMENT RELAXATION STATE

(71) Applicant: Nokia Technologies Oy, Espoo (FI)

(72) Inventors: Halit Murat GÜRSU, Munich (DE); Ahmad AWADA, Munich (DE); Panagiotis SPAPIS, Munich (DE); Srinivasan SELVAGANAPATHY, Bangalore (IN)

(21) Appl. No.: 18/820,473

(22) Filed: Aug. 30, 2024

(30) Foreign Application Priority Data
Sep. 1, 2023 (IN) 202341058835

(51) Int. Cl. H04W 24/02; H04W 36/00; H04W 36/08; H04W 68/02

(52) U.S. Cl. CPC H04W 24/02; H04W 36/0058; H04W 36/08; H04W 68/02

(57) ABSTRACT

Disclosed is a method comprising logging information related to a radio resource management relaxation state of the apparatus; generating a message comprising the information, wherein the message is generated based on a failure or a status of the apparatus in an idle mode or in an inactive mode; and transmitting the message.

### FIELD

The following example embodiments relate to wireless communication.

### BACKGROUND

Radio resource management relaxation may be used to enable a user equipment to perform mobility-related measurements less frequently, for example. However, incorrect radio resource management relaxation parameters may lead to, for example, connection establishment failure or paging failure. Thus, it is desirable to avoid incorrect radio resource management relaxation parameters.

### BRIEF DESCRIPTION

The scope of protection sought for various example embodiments is set out by the claims. The example embodiments and features, if any, described in this specification that do not fall under the scope of the claims are to be interpreted as examples useful for understanding various embodiments.

According to an aspect, there is provided an apparatus comprising at least one processor, and at least one memory storing instructions that, when executed by the at least one processor, cause the apparatus at least to: log information related to a radio resource management relaxation state of the apparatus; generate a message comprising the information, wherein the message is generated based on a failure or a status of the apparatus in an idle mode or in an inactive mode; and transmit the message.

According to another aspect, there is provided an apparatus comprising: means for logging information related to a radio resource management relaxation state of the apparatus; means for generating a message comprising the information, wherein the message is generated based on a failure or a status of the apparatus in an idle mode or in an inactive mode; and means for transmitting the message.

According to another aspect, there is provided a method comprising: logging, by an apparatus, information related to a radio resource management relaxation state of the apparatus; generating, by the apparatus, a message comprising the information, wherein the message is generated based on a failure or a status of the apparatus in an idle mode or in an inactive mode; and transmitting the message by the apparatus.

According to another aspect, there is provided a computer program comprising instructions which, when executed by an apparatus, cause the apparatus to perform at least the following: logging information related to a radio resource management relaxation state of the apparatus; generating a message comprising the information, wherein the message is generated based on a failure or a status of the apparatus in an idle mode or in an inactive mode; and transmitting the message.

According to another aspect, there is provided a computer readable medium comprising program instructions which, when executed by an apparatus, cause the apparatus to perform at least the following: logging information related to a radio resource management relaxation state of the apparatus; generating a message comprising the information, wherein the message is generated based on a failure or a status of the apparatus in an idle mode or in an inactive mode; and transmitting the message.

According to another aspect, there is provided a non-transitory computer readable medium comprising program instructions which, when executed by an apparatus, cause the apparatus to perform at least the following: logging information related to a radio resource management relaxation state of the apparatus; generating a message comprising the information, wherein the message is generated based on a failure or a status of the apparatus in an idle mode or in an inactive mode; and transmitting the message.

According to another aspect, there is provided an apparatus comprising at least one processor, and at least one memory storing instructions that, when executed by the at least one processor, cause the apparatus at least to: receive, from a user equipment, a message comprising information related to a radio resource management relaxation state of the user equipment, wherein the message is based on a failure or a status of the user equipment in an idle mode or in an inactive mode; determine, based on the information, a cell in which the user equipment experienced the radio resource management relaxation state; and forward the message to a network node controlling the cell.

According to another aspect, there is provided an apparatus comprising: means for receiving, from a user equipment, a message comprising information related to a radio resource management relaxation state of the user equipment, wherein the message is based on a failure or a status of the user equipment in an idle mode or in an inactive mode; means for determining, based on the information, a cell in which the user equipment experienced the radio resource management relaxation state; and means for forwarding the message to a network node controlling the cell.

According to another aspect, there is provided a method comprising: receiving, from a user equipment, a message comprising information related to a radio resource management relaxation state of the user equipment, wherein the message is based on a failure or a status of the user equipment in an idle mode or in an inactive mode; determining, based on the information, a cell in which the user equipment experienced the radio resource management relaxation state; and forwarding the message to a network node controlling the cell.

According to another aspect, there is provided a computer program comprising instructions which, when executed by an apparatus, cause the apparatus to perform at least the following: receiving, from a user equipment, a message comprising information related to a radio resource management relaxation state of the user equipment, wherein the message is based on a failure or a status of the user equipment in an idle mode or in an inactive mode; determining, based on the information, a cell in which the user equipment experienced the radio resource management relaxation state; and forwarding the message to a network node controlling the cell.

According to another aspect, there is provided a computer readable medium comprising program instructions which, when executed by an apparatus, cause the apparatus to perform at least the following: receiving, from a user equipment, a message comprising information related to a radio resource management relaxation state of the user equipment, wherein the message is based on a failure or a status of the user equipment in an idle mode or in an inactive mode; determining, based on the information, a cell in which the user equipment experienced the radio resource management relaxation state; and forwarding the message to a network node controlling the cell.

According to another aspect, there is provided a non-transitory computer readable medium comprising program instructions which, when executed by an apparatus, cause the apparatus to perform at least the following: receiving, from a user equipment, a message comprising information related to a radio resource management relaxation state of the user equipment, wherein the message is based on a failure or a status of the user equipment in an idle mode or in an inactive mode; determining, based on the information, a cell in which the user equipment experienced the radio resource management relaxation state; and forwarding the message to a network node controlling the cell.

According to another aspect, there is provided an apparatus comprising at least one processor, and at least one memory storing instructions that, when executed by the at least one processor, cause the apparatus at least to: receive a message comprising information related to a radio resource management relaxation state of a user equipment, wherein the message is based on a failure or a status of the user equipment in an idle mode or in an inactive mode; and adjust, based at least partly on the information, one or more radio resource management relaxation parameters associated with triggering the radio resource management relaxation state.

According to another aspect, there is provided an apparatus comprising: means for receiving a message comprising information related to a radio resource management relaxation state of a user equipment, wherein the message is based on a failure or a status of the user equipment in an idle mode or in an inactive mode; and means for adjusting, based at least partly on the information, one or more radio resource management relaxation parameters associated with triggering the radio resource management relaxation state.

According to another aspect, there is provided a method comprising: receiving a message comprising information related to a radio resource management relaxation state of a user equipment, wherein the message is based on a failure or a status of the user equipment in an idle mode or in an inactive mode; and adjusting, based at least partly on the information, one or more radio resource management relaxation parameters associated with triggering the radio resource management relaxation state.

According to another aspect, there is provided a computer program comprising instructions which, when executed by an apparatus, cause the apparatus to perform at least the following: receiving a message comprising information related to a radio resource management relaxation state of a user equipment, wherein the message is based on a failure or a status of the user equipment in an idle mode or in an inactive mode; and adjusting, based at least partly on the information, one or more radio resource management relaxation parameters associated with triggering the radio resource management relaxation state.

According to another aspect, there is provided a computer readable medium comprising program instructions which, when executed by an apparatus, cause the apparatus to perform at least the following: receiving a message comprising information related to a radio resource management relaxation state of a user equipment, wherein the message is based on a failure or a status of the user equipment in an idle mode or in an inactive mode; and adjusting, based at least partly on the information, one or more radio resource management relaxation parameters associated with triggering the radio resource management relaxation state.

According to another aspect, there is provided a non-transitory computer readable medium comprising program instructions which, when executed by an apparatus, cause the apparatus to perform at least the following: receiving a message comprising information related to a radio resource management relaxation state of a user equipment, wherein the message is based on a failure or a status of the user equipment in an idle mode or in an inactive mode; and adjusting, based at least partly on the information, one or more radio resource management relaxation parameters associated with triggering the radio resource management relaxation state.

### LIST OF DRAWINGS

In the following, various example embodiments will be described in greater detail with reference to the accompanying drawings, in which:

FIG. 1A illustrates an example of a wireless communication network;

FIG. 1B illustrates an example of a system;

FIG. 2A illustrates an example of a radio resource management relaxation configuration scenario;

FIG. 2B illustrates an example of a radio resource management relaxation configuration scenario;

FIG. 2C illustrates an example of a radio resource management relaxation configuration scenario;

FIG. 3 illustrates a signal flow diagram;

FIG. 4 illustrates a signal flow diagram;

FIG. 5 illustrates a signal flow diagram;

FIG. 6 illustrates a signal flow diagram;

FIG. 7 illustrates a flow chart;

FIG. 8 illustrates a flow chart;

FIG. 9 illustrates a flow chart;

FIG. 10 illustrates an example of an apparatus; and

FIG. 11 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Some example embodiments described herein may be implemented in a wireless communication network comprising a radio access network based on one or more of the following radio access technologies (RATs): Global System for Mobile Communications (GSM) or any other second generation radio access technology, Universal Mobile Telecommunication System (UMTS, 3G) based on basic wideband-code division multiple access (W-CDMA), high-speed packet access (HSPA), Long Term Evolution (LTE), LTE-Advanced, fourth generation (4G), fifth generation (5G), 5G new radio (NR), 5G-Advanced (i.e., 3GPP NR Rel-18 and beyond), or sixth generation (6G). Some examples of radio access networks include the universal mobile telecommunications system (UMTS) radio access network (UTRAN), the Evolved Universal Terrestrial Radio Access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications. IEEE is an abbreviation for the Institute of Electrical and Electronics Engineers.

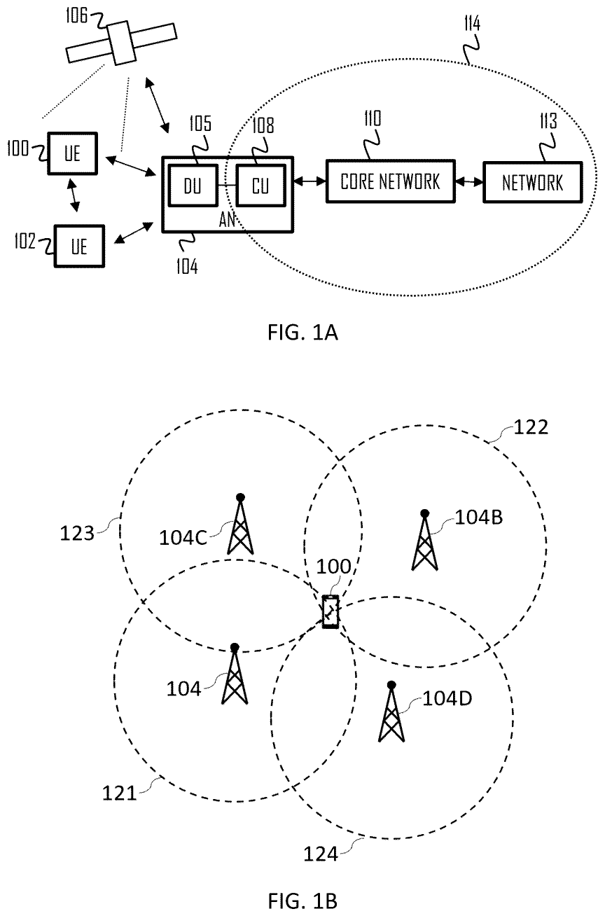

FIG. 1A depicts an example of a simplified wireless communication network showing some physical and logical entities. The connections shown in FIG. 1A may be physical connections or logical connections. It is apparent to a person skilled in the art that the wireless communication network may also comprise other physical and logical entities than those shown in FIG. 1A.

The example embodiments described herein are not, however, restricted to the wireless communication network given as an example but a person skilled in the art may apply the embodiments described herein to other wireless communication networks provided with necessary properties.

The example wireless communication network shown in FIG. 1A includes an access network, such as a radio access network (RAN), and a core network 110.

FIG. 1A shows user equipment (UE) 100, 102 configured to be in a wireless connection on one or more communication channels in a radio cell with an access node (AN) 104 of an access network. The AN 104 may be an evolved NodeB (abbreviated as eNB or eNodeB), or a next generation evolved NodeB (abbreviated as ng-eNB), or a next generation NodeB (abbreviated as gNB or gNodeB), providing the radio cell. The wireless connection (e.g., radio link) from a UE to the access node 104 may be called uplink (UL) or reverse link, and the wireless connection (e.g., radio link) from the access node to the UE may be called downlink (DL) or forward link. UE 100 may also communicate directly with UE 102, and vice versa, via a wireless connection generally referred to as a sidelink (SL). It should be appreciated that the access node 104 or its functionalities may be implemented by using any node, host, server or access point etc. entity suitable for providing such functionalities.

The access network may comprise more than one access node, in which case the access nodes may also be configured to communicate with one another over links, wired or wireless. These links between access nodes may be used for sending and receiving control plane signaling and also for routing data from one access node to another access node.

The access node may comprise a computing device configured to control the radio resources of the access node. The access node may also be referred to as a base station, a base transceiver station (BTS), an access point, a cell site, a radio access node or any other type of node capable of being in a wireless connection with a UE (e.g., UEs 100, 102). The access node may include or be coupled to transceivers. From the transceivers of the access node, a connection may be provided to an antenna unit that establishes bi-directional radio links to UEs 100, 102. The antenna unit may comprise an antenna or antenna element, or a plurality of antennas or antenna elements.

The access node 104 may further be connected to a core network (CN) 110. The core network 110 may comprise an evolved packet core (EPC) network and/or a 5th generation core network (5GC). The EPC may comprise network entities, such as a serving gateway (S-GW for routing and forwarding data packets), a packet data network gateway (P-GW) for providing connectivity of UEs to external packet data networks, and a mobility management entity (MME). The 5GC may comprise network functions, such as a user plane function (UPF), an access and mobility management function (AMF), and a location management function (LMF).

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device just to mention but a few names. The UE may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or any computing device comprising a wireless modem integrated in a vehicle.

It should be appreciated that a UE may also be a nearly exclusive uplink-only device, of which an example may be a camera or video camera loading images or video clips to a network. A UE may also be a device having capability to operate in an Internet of Things (IoT) network, which is a scenario in which objects may be provided with the ability to transfer data over a network without requiring human-to-human or human-to-computer interaction. The UE may also utilize cloud. In some applications, the computation may be carried out in the cloud or in another UE.

The wireless communication network may also be able to support the usage of cloud services, for example at least part of core network operations may be carried out as a cloud service (this is depicted in FIG. 1A by “cloud” 114). The wireless communication network may also comprise a central control entity, or the like, providing facilities for wireless communication networks of different operators to cooperate for example in spectrum sharing.

5G enables using multiple input-multiple output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine type applications, such as (massive) machine-type communications (mMTC), including vehicular safety, different sensors and real-time control.

In 5G wireless communication networks, access nodes and/or UEs may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, a 5G wireless communication network may support both inter-RAT operability (such as LTE-5G) and inter-RI operability (inter-radio interface operability, such as below 6 GHz-cmWave-mmWave). One of the concepts considered to be used in 5G wireless communication networks may be network slicing, in which multiple independent and dedicated virtual sub-networks (network instances) may be created within the substantially same infrastructure to run services that have different requirements on latency, reliability, throughput and mobility.

In some example embodiments, an access node (e.g., access node 104) may comprise: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node. The DU 105 may be a logical node hosting radio link control (RLC), medium access control (MAC) and/or physical (PHY) layers of the NR protocol stack for the access node. The operations of the DU may be at least partly controlled by the CU. It should also be understood that the distribution of functions between DU 105 and CU 108 may vary depending on implementation. The CU may comprise a control plane (CU-CP), which may be a logical node hosting the RRC and the control plane part of the PDCP protocol of the NR protocol stack for the access node. The CU may further comprise a user plane (CU-UP), which may be a logical node hosting the user plane part of the PDCP protocol and the SDAP protocol of the CU for the access node.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the access network (e.g., RAN) by utilizing network function virtualization (NFV) and software defined networking (SDN). Using edge cloud may mean access node operations to be carried out, at least partly, in a computing system operationally coupled to a remote radio head (RRH) or a radio unit (RU) of an access node. It is also possible that access node operations may be performed on a distributed computing system or a cloud computing system located at the access node. Application of cloud RAN architecture enables RAN real-time functions being carried out at the access network (e.g., in a DU 105) and non-real-time functions being carried out in a centralized manner (e.g., in a CU 108).

It should also be understood that the distribution of functions between core network operations and access node operations may differ in future wireless communication networks compared to that of the LTE or 5G, or even be non-existent. Some other technology advancements that may be used include big data and all-IP, which may change the way wireless communication networks are being constructed and managed. 5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network, enabling more extensive network coverage. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay access node or by an access node 104 located on-ground or in a satellite.

It is obvious for a person skilled in the art that the access node 104 depicted in FIG. 1A is just an example of a part of an access network (e.g., a radio access network) and in practice, the access network may comprise a plurality of access nodes, the UEs 100, 102 may have access to a plurality of radio cells, and the access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of an access network (e.g., a radio access network), a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1A may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of access networks, the concept of “plug-and-play” access nodes may be introduced. An access network which may be able to use “plug-and-play” access nodes, may include, in addition to Home e NodeBs or Home gNodeBs, a Home Node B gateway, or HNB-GW (not shown in FIG. 1A). An HNB-GW, which may be installed within an operator's access network, may aggregate traffic from a large number of Home eNodeBs or Home gNodeBs back to a core network of the operator.

FIG. 1B illustrates an example of a system, to which some example embodiments may be applied. FIG. 1B may be understood to depict a part of the wireless communication network of FIG. 1A, but with greater accuracy with respect to cell re-selection. The system comprises at least a UE 100 and a plurality of RAN nodes 104, 104B, 104C, 104D (e.g., gNBs) controlling a plurality of cells 121, 122, 123, 124. Herein the term “cell” refers to a radio cell. Although four cells 121, 122, 123, 124 and four RAN nodes 104, 104B, 104C, 104D are shown in FIG. 1B, it should be noted that the number of cells and RAN nodes may also be higher or lower than four.

With cell selection, the UE 100 searches for a suitable cell of the selected public land mobile network (PLMN) or selected stand-alone non-public network (SNPN), chooses that cell to provide available services, and monitors its control channel. This procedure is defined as “camping on the cell”. If the UE 100 finds a more suitable cell, according to the cell re-selection criteria, the UE 100 re-selects onto that cell and camps on it. For example, cell re-selection may be based on measurements and evaluations of signal strength, quality, and/or other parameters of the current serving cell 121 and one or more neighboring cells 122, 123, 124. The UE 100 may autonomously make the decision to re-select a different cell in idle (RRC_IDLE) mode, or if the UE experiences a radio link failure.

In NR Release 17 (Rel-17), the 3rd generation partnership project (3GPP) has introduced a type of low-complexity and power-efficient UEs called reduced capability (RedCap) devices. RedCap devices may also be referred to as RedCap UEs, NR-Lite devices, or NR-Light devices.

RedCap devices may have, for example, the following features: a reduced number of transmit and/or receive antennas, reduced bandwidth, and low energy consumption compared to non-RedCap UEs. However, RedCap devices may also be associated with certain latency guarantees and service availability requirements.

Industrial wireless sensors are one example of RedCap devices. It may be desirable to connect industrial wireless sensors to 5G radio access and core networks in order to improve flexibility, enhance productivity and efficiency, and improve operational safety. Industrial wireless sensors may comprise, for example, pressure sensors, humidity sensors, thermometers, motion sensors, and/or accelerometers, etc. For industrial wireless sensor use cases, RedCap devices may have the following requirements: communication service availability is at least 99.99%, end-to-end latency is less than 100 ms, the reference bit rate is less than 2 Mbps (potentially asymmetric, e.g., UL heavy traffic), and the device is expected to be mostly stationary. The battery may be required to last at least a few years. For safety-related sensors, the latency requirement may be more stringent, for example 5-10 ms.

Video surveillance cameras are another example of RedCap devices. The deployment of surveillance cameras may be beneficial, for example, for smart city use cases, as well as for factories and industries, in order to monitor and control city or factory resources more efficiently. The following requirements may apply for video surveillance use cases: the reference economic video bitrate is 2-4 Mbps, latency is less than 500 ms, and the reliability is at least 99%-99.9%. High-end video applications (e.g., for farming) may require a video bitrate of 7.5-25 Mbps. It is noted that the traffic pattern may be dominated by UL transmissions.

Wearables, such as smart watches, rings, eHealth-related devices, personal protection equipment, and/or medical monitoring devices, are another example of RedCap devices. The following requirements may apply for wearables: the reference bitrate for smart wearable applications is 5-50 Mbps in DL and 2-5 Mbps in UL, and the peak bit rate of the device may be higher, for example up to 150 Mbps for DL and up to 50 Mbps for UL. In addition, the battery of the wearable device should last multiple days (e.g., up to 1-2 weeks).

For example, UE energy consumption may be reduced by reducing the UE measurement frequency such that the measurements are performed less frequently. Optimizing energy consumption of UEs through reduced measurement frequency can be investigated in two branches. The first branch is mobility-related measurements, and the second branch is user plane-related measurements. Radio resource management (RRM) relaxation investigates the mobility-related measurements. RRM relaxation may also be referred to as RRM measurement relaxation. RRM relaxation comprises two components: an RRM relaxation trigger, and RRM measurement relaxation.

The RRM relaxation trigger comprises one or more criteria, either configured to the UE or acquired by the UE from the serving cell, that are used to initiate RRM relaxation. For example, the RRM relaxation trigger may comprise at least one of the following criteria: a low-mobility criterion, a not-at-cell-edge criterion, or a stationarity criterion.

The low-mobility criterion aims to identify a UE in a low mobility state. The low-mobility criterion compares the difference in reference signal received power (RSRP) between two time instances (denoted as t and t+x):

(RSRPrxRef(t)−RSRPrx(t+x))<S_SearchDeltaP,

where RSRPrx is the current RSRP value of the serving gNB, and RSRPrxRef is a reference RSRP value that may be updated in three different ways. Firstly, RSRPrxRef may be updated to the RSRP value of the serving gNB after selecting or re-selecting a new gNB. Secondly, RSRPrxRef may be updated to the new RSRP value, when the UE is moving closer to the cell center, i.e., (RSRPrx-RSRPrxRef)>0. Thirdly, if the RRM relaxation criterion has not been met for a time period T_SearchDeltaP (denoted by x in the above equation), the UE may set the value of RSRPrxRef to the current RSRPrx value. S_SearchDeltaP is a threshold configured to the UE to monitor the received signal variation. The values of S_SearchDeltaP and T_SearchDeltaP may be used to define the mobility level of the UE.

The not-at-cell-edge criterion aims to detect whether or not the UE is at the cell edge of the serving cell. If the not-at-cell-edge criterion is fulfilled, then it may mean that the UE is not at the cell edge of the serving cell. In order to detect whether the UE is at the cell edge or not, the UE may compare the received signal level against a threshold as follows:

RSRPrx>S_SearchThresholdP,

where RSRPrx is the current RSRP value of the serving gNB, and S_SearchThresholdP is the RSRP threshold set for the not-at-cell-edge criterion. The not-at-cell-edge criterion is fulfilled, when RSRPrx is above the threshold S_SearchThresholdP (i.e., the UE is not at the cell edge).

As an alternative to RSRP, the above thresholds and conditions may be configured with reference signal received quality (RSRQ) values. For example, a parameter called S_SearchThresholdQ may be used instead of S_SearchThresholdP to specify an RSRQ threshold for the not-at-cell-edge criterion.

The stationarity criterion aims to identify whether the UE is stationary. The stationarity criterion may be used to enable longer RRM relaxation compared to the low-mobility criterion and the not-at-cell-edge criterion.

A given UE may be configured to monitor at least one of the RRM relaxation triggers (criteria). The network (e.g., the serving gNB) may configure the at least one trigger to the UE independently. In case the RRM relaxation is triggered with respect to its configuration, the UE may apply RRM measurement relaxation.

There are multiple ways to relax the RRM measurements. For example, the UE may relax the measurements for a specific set of cells (e.g., the serving cell 121 or one or more neighboring cells 122, 123, 124), or perform less frequent RRM measurements for some cell(s). In other words, in case the RRM relaxation is triggered, the UE may adjust the measurement periodicity for the serving cell 121 and/or one or more neighboring cells 122, 123, 124 in order to perform the RRM measurements less frequently. Relaxed measurements with longer intervals (scaling factor) can be configured. For example, the UE may stop the RRM measurements for up to 1 hour upon triggering the RRM relaxation.

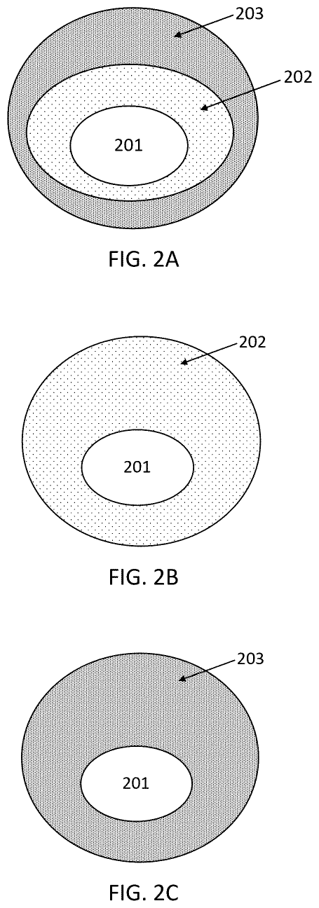

FIG. 2A, FIG. 2B, and FIG. 2C illustrate some examples of RRM relaxation configuration scenarios.

FIG. 2A illustrates an example of an ideal RRM relaxation configuration. Without the RRM relaxation feature, cell re-selection comes with two parameters: S_IntraSearchP and S_IntraSearchQ. These parameters may be used to detect whether the UE is in the cell center 201 of the serving cell 121. In the cell center 201, the UE does not perform measurements of the neighboring cells 122, 123, 124. Outside of the cell center 201, in the area 203 close to the cell edge, the UE does normal neighbor cell measurements. RRM relaxation introduces a new area 202 between the cell center 201 and the cell edge area 203, where the UE does less frequent measurements of the neighboring cells (compared to the cell edge area 203) as configured with the RRM relaxation configuration. The RRM relaxation area 202 serves as a transition area to the cell edge area 203, where the UE needs to perform non-relaxed measurements as it is approaching the cell edge.

FIG. 2B illustrates an example of a failure setting, where the RRM relaxation threshold (e.g., S_SearchThresholdP) is set too high, and therefore the not-at-cell-edge criterion remains fulfilled even when the UE is actually at the cell edge of the serving cell 121 (i.e., the RRM relaxation area 202 also covers the cell edge area), and thus the UE does not detect the neighbor cells 122, 123, 124 at the right time.

FIG. 2C illustrates an example of a failure setting, where the RRM relaxation threshold (e.g., S_SearchThresholdP) is set too low, and therefore the RRM relaxation is never initiated.

RRM relaxation impacts UE measurements in RRC idle or inactive mode, which are used in the cell re-selection procedure. In case the RRM relaxation parameters are set to stop the UE from measuring neighboring cells when it should not (e.g., see FIG. 2B), it can lead to following issues: a connection establishment failure due to incorrectly set RRM relaxation parameter, or a paging reception failure due to incorrectly set RRM relaxation parameter.

For example, the connection establishment failure may occur when the UE has moved to the coverage of another cell 122 and is receiving heavy interference from the new cell 122. When the UE tries to establish a connection to the last cell 121 that the UE is still camping on, the connection establishment may fail due to interference.

Similarly, the paging reception failure may occur when UE has moved to the coverage of another cell 122 and is receiving heavy interference from the new cell 122. When the serving cell 121 that the UE is camping on pages the UE, the UE may not be able to decode the paging message due to interference. After a timeout for initial paging, the network may try to page the UE in one or more neighboring cells 122. When the new cell 122 is paging the UE as part of the paging retransmission, even though another cell pages the UE if the cell belongs to the registration area of the UE, the UE does not monitor the paging occasions of any other cell than the serving cell 121 that it is camping on, and thus the UE cannot receive the paging message from the new cell 122.

On the other hand, in case the RRM relaxation parameters are set to allow the UE to measure neighboring cells when it should not (e.g., see FIG. 2C), it can lead to a UE energy consumption issue, since the UE cannot stop or relax measuring the neighboring cells, for example. This misconfiguration undermines the feature of RRM measurement relaxation, whose aim is to reduce the UE energy consumption in the case when there is no need to perform the measurements (e.g., when the UE is in low mobility and/or not at the cell edge).

As such, the settings of the parameters controlling the RRM relaxation triggers (e.g., S_SearchDeltaP and T_SearchDeltaP for the low-mobility criterion, and/or S_SearchThresholdP or S_SearchThresholdQ for the not-at-cell-edge criterion) need to be properly configured such that the above issues are avoided, while the energy saving of the UE is maximized.

When experiencing a connection establishment failure, the UE can report this failure to the network with a ConnEstFailReport message using idle logging mechanisms. Using the reported information, the network becomes aware of the connection establishment failure and can understand that is related to incorrect setting of the UE neighbor cell measurements. However, based on the connection establishment failure report alone, the network will not know the root cause of the connection establishment failure. Therefore, the network does not know which specific parameter is set incorrectly. For example, the connection establishment failure may be caused by incorrect cell re-selection parameters (e.g., S_IntraSearchP and S_IntraSearchQ) or incorrect RRM relaxation parameters (e.g., S_SearchDeltaP, T_SearchDeltaP, S_SearchThresholdP).

Some example embodiments may enable the network to do a root cause analysis for incorrect setting of RRM relaxation parameters and to adjust them accordingly. For example, the UE may include, in a UE information report, information of the RRM relaxation state of the UE and performance indicators related to connection setup failure or paging failure and RRM relaxation monitoring efficiency to enable the network to optimize the network configuration for the RRM relaxation functionality. In the following example embodiments, the UE and network related signalling are defined to enable the optimization of the parameters controlling RRM relaxation. The connection setup failure (herein also referred to as connection establishment failure below) may comprise the RRC connection setup failure when the UE is in idle (RRC_IDLE) mode and the RRC connection resume failure when the UE is in inactive (RRC_INACTIVE) mode.

Some example embodiments are described below using principles and terminology of 5G radio access technology without limiting the example embodiments to 5G radio access technology, however.

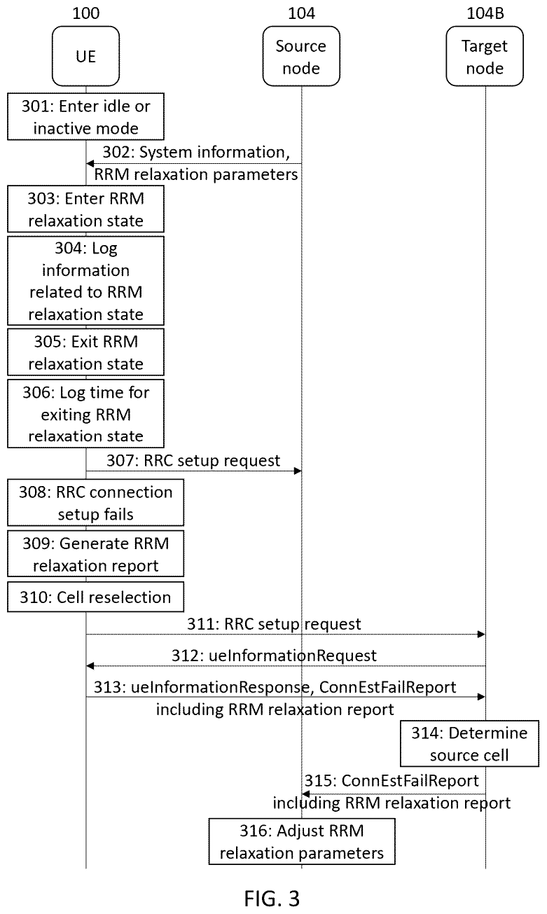

FIG. 3 illustrates a signal flow diagram according to an example embodiment for solving the connection establishment failure issue. In this example embodiment, the connection establishment failure report may be enhanced to comprise information related to the RRM relaxation state. This example embodiment may enable the network to perform closed-loop optimization of the RRM relaxation parameters, and thus help to minimize connection establishment failures caused by the misconfiguration of the RRM relaxation parameters.

Referring to FIG. 3, at 301, the UE 100 enters idle (RRC_IDLE) mode or inactive (RRC_INACTIVE) mode. The UE 100 may be a reduced capability (RedCap) device or any other type of UE.

At 302, a source network node 104 transmits, or broadcasts, system information comprising one or more radio resource management (RRM) relaxation parameters on a cell 121 controlled by the source network node 104. The UE 100 receives the system information from the source network node 104 on the cell 121 that the UE 100 is currently camping on.

For example, the one or more RRM relaxation parameters may comprise at least one of: S_SearchDeltaP, T_SearchDeltaP, S_SearchThresholdP, or S_SearchThresholdQ.

S_SearchDeltaP specifies a threshold (e.g., in decibels) on the received signal level variation for the low-mobility criterion.

T_SearchDeltaP specifies the time period over which the received signal level variation is evaluated for the low-mobility criterion.

S_SearchThresholdP specifies a received signal level threshold (e.g., in decibels) for the not-at-cell-edge criterion.

S_SearchThresholdQ specifies a received signal quality threshold (e.g., in decibels) for the not-at-cell-edge criterion.

At 303, the UE 100 enters an RRM relaxation state due to at least one RRM relaxation trigger associated with the one or more RRM relaxation parameters being fulfilled. The at least one RRM relaxation trigger may comprise at least one of: the low-mobility criterion, the stationarity criterion, or the not-at-cell edge criterion. For example, the UE 100 may fulfill the not-at-cell-edge criterion due to moving in the cell 121. In the RRM relaxation state, the UE 100 performs less frequent measurements (e.g., RSRP and/or RSRQ measurements) of one or more neighboring cells 122, 123, 124, and the UE 100 may delay cell re-selection due to the less frequent measurements.

At 304, the UE 100 logs information related to the RRM relaxation state of the UE 100 based on entering the RRM relaxation state.

For example, before or upon entering the RRM relaxation state, the UE 100 may log one or more radio measurements (e.g., RSRP and/or RSRQ) of the serving cell 121 and/or one or more radio measurements (e.g., RSRP and/or RSRQ) of the one or more neighboring cells 122, 123, 124 that were obtained before entering the RRM relaxation state in the serving cell 121. In other words, the UE 100 may log the last measurements of the serving cell 121 and the one or more neighboring cells 122, 123, 124. The last cell measurements may be a trace of measurements that are collected over a certain period of time. The serving cell 121 may also be referred to as a source cell herein.

Alternatively, or additionally, the UE 100 may log the time of entering the RRM relaxation state.

Alternatively, or additionally, the UE 100 may log the at least one RRM relaxation trigger that was fulfilled and thus caused entering the RRM relaxation state.

At 305, the UE 100 may exit the RRM relaxation state. For example, the at least one RRM relaxation trigger may not be fulfilled anymore due to the UE 100 moving in the cell 121 (e.g., due to moving to the cell edge).

Alternatively, the UE 100 may remain in the RRM relaxation state until the UE enters connected mode (e.g., until 311).

At 306, the UE 100 may log information related to the RRM relaxation state of the UE 100 based on exiting the RRM relaxation state. For example, the UE 100 may log the time of exiting the RRM relaxation state. Alternatively, or additionally, the UE 100 may log the duration of being in the RRM relaxation state.

After exiting the RRM relaxation state, the UE 100 may continue the measurements.

At 307, if the UE is in idle (RRC_IDLE) mode, the UE 100 transmits an RRC setup request message to the source network node 104 controlling the cell 121 that the UE 100 is camping on. With the RRC setup request message, the UE 100 requests the establishment of an RRC connection with the source network node 104.

At 308, the RRC connection establishment fails, as the UE 100 is too far away from the serving cell 121, and thus the source network node 104 cannot decode the RRC setup request message.

At 309, the UE 100 generates a message (called RRM relaxation report herein) comprising the logged information related to the RRM relaxation state, wherein the message is generated based on the RRC connection establishment failure of the UE 100 in the idle mode or in the inactive mode.

For example, the information in the RRM relaxation report may comprise at least one of: the time of entering the RRM relaxation state, the time of exiting the RRM relaxation state, the duration of the RRM relaxation state, the at least one RRM relaxation trigger that caused entering the RRM relaxation state, the identity of the serving cell 121 on which the one or more RRM relaxation parameters used for evaluating the at least one RRM relaxation trigger were obtained, or the one or more RRM relaxation parameters used for evaluating the at least one RRM relaxation trigger.

It should be noted that the source network node 104 may store the one or more RRM relaxation parameters configured to the UE 100 at 302 (e.g., in a log). In this case, the UE 100 does not need to include the one or more RRM relaxation parameters in the RRM relaxation report, since they are already known by the source network node 104.

The RRM relaxation report may further comprise: the one or more radio measurements of the serving cell 121 that were obtained before entering the RRM relaxation state in the serving cell 121, the one or more radio measurements of the one or more neighboring cells 122, 123, 124 that were obtained before entering the RRM relaxation state in the serving cell 121, and information related to the connection establishment failure in the serving cell 121.

At 310, the UE 100 performs a cell re-selection procedure to re-select to one of the neighboring cells (e.g., a neighboring cell 122) controlled by a target network node 104B (i.e., to have the neighboring cell 122 become the new serving cell of the UE 100). For example, the cell re-selection may be based on new measurements of the serving cell 121 and the one or more neighboring cells 122, 123, 124 that are obtained during the RRM relaxation state or after exiting the RRM relaxation state.

At 311, if the UE is in idle (RRC_IDLE) mode, the UE 100 transmits an RRC setup request message to the target network node 104B controlling the neighboring cell 122. The RRC setup request message transmitted to the target network node 104B indicates availability of the logged measurements of the serving cell 121 and the one or more neighboring cells 122, 123, 124. The target network node 104B receives the RRC setup request message from the UE 100.

At 312, the target network node 104B transmits an UE information request message to the UE 100 to request the UE 100 to report the measurements.

At 313, in response to receiving the UE information request message, the UE 100 transmits an UE information response message to the target network node 104B, wherein the UE information response message comprises a connection establishment failure report (ConnEstFailReport) message comprising the RRM relaxation report. In other words, the RRM relaxation report is transmitted based at least on performing the cell re-selection to the neighboring cell 122. The target network node 104B receives the UE information response message.

Alternatively, the RRM relaxation report may be transmitted as a separate message instead of including it in the ConnEstFailReport message.

At 314, the target network node 104B determines, based on the information in the RRM relaxation report, the identity of the source cell 121 in which the UE 100 experienced the RRM relaxation state. For example, the identity of the source cell 121 may be included in the RRM relaxation report, and the target network node 104B may then map the identity of the source cell 121 to the source network node 104 controlling the source cell 121.

At 315, based on the determination, the target network node 104B forwards the connection establishment failure report to the source network node 104 controlling the source cell 121. The source network node 104 receives the connection establishment failure report comprising the RRM relaxation report.

At 316, the source network node 104 adjusts or optimizes, based at least partly on the information in the RRM relaxation report of the UE 100, the one or more RRM relaxation parameters associated with triggering the RRM relaxation state. As an example, the source network node 104 may decrease the S_SearchThresholdP parameter in order to enable UEs to detect the cell edge of the serving cell 121 earlier, and thus avoid connection establishment failures on the serving cell 121 in the future. The source network node 104 may collect RRM relaxation reports from multiple UEs before performing the adjustment or optimization.

For example, if the RRM relaxation report indicates the at least one RRM relaxation trigger that caused the UE 100 to enter the RRM relaxation state, then this information may enable root cause analysis and optimization of the one or more RRM relaxation parameters.

For example, the source network node 104 may use self-organizing network (SON) mechanisms or artificial intelligence or machine learning techniques to optimize the one or more RRM relaxation parameters.

The source network node 104 may transmit the adjusted one or more RRM relaxation parameters to one or more other UEs 102 in the source cell 121 (e.g., in system information). The adjusted one or more RRM relaxation parameters may not be transmitted to the UE 100, since the UE 100 is no longer in the source cell 121. However, if the UE 100 re-selects back to the source cell 121, then the UE 100 may receive the adjusted one or more RRM relaxation parameters from the source network node 104.

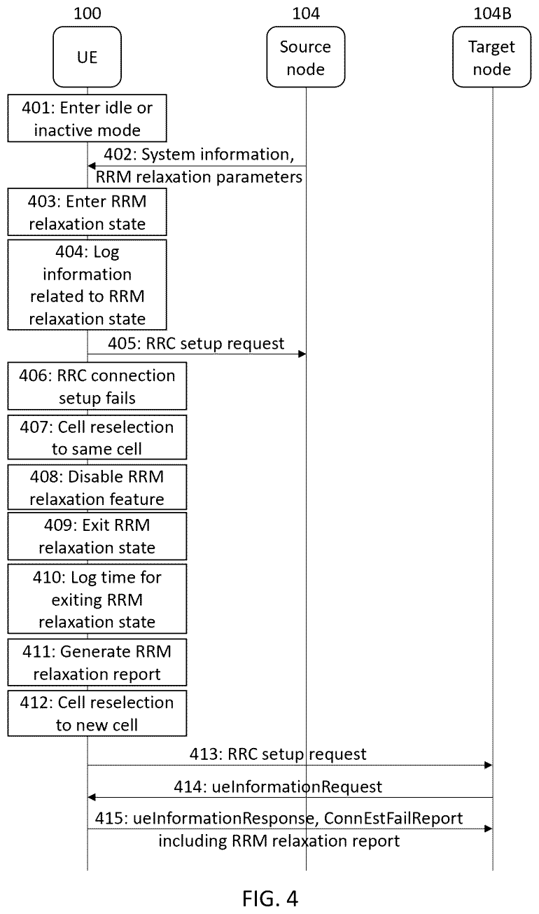

FIG. 4 illustrates a signal flow diagram according to an example embodiment for solving the connection establishment failure issue and partly the paging failure issue. If the connection establishment fails or if the UE fails to decode a physical downlink shared channel (PDSCH) for paging, and if within a certain time limit after the failure the UE selects the same cell as its serving cell for idle mode, the UE may disable the RRM relaxation functionality to identify the best cell for re-selection to avoid further failures. The network may configure the UE to enable or disable this capability (e.g., with an additional parameter called ‘disable-relaxed-monitoring-after-failure’). In this case, the UE may report this ‘fallback’ status in the next connection setup via a new cell as an additional parameter in an RRC message on the new cell.

Referring to FIG. 4, at 401, the UE 100 enters idle (RRC_IDLE) mode or inactive (RRC_INACTIVE) mode. The UE 100 may be a reduced capability (RedCap) device or any other type of UE.

The idle mode refers to a state where the UE is not connected to any cell. The inactive mode refers to a state, where the UE 100 maintains its connection to the network but suspends data transmission to save power.

At 402, a source network node 104 transmits, or broadcasts, system information comprising one or more radio resource management (RRM) relaxation parameters on a cell 121 controlled by the source network node 104. The UE 100 receives the system information from the source network node 104 on the cell 121 that the UE 100 is currently camping on.

For example, the one or more RRM relaxation parameters may comprise at least one of: S_SearchDeltaP, T_SearchDeltaP, S_SearchThresholdP, or S_SearchThresholdQ.

S_SearchDeltaP specifies a threshold (e.g., in decibels) on the received signal level variation for the low-mobility criterion.

T_SearchDeltaP specifies the time period over which the received signal level variation is evaluated for the low-mobility criterion.

S_SearchThresholdP specifies a received signal level threshold (e.g., in decibels) for the not-at-cell-edge criterion.

S_SearchThresholdQ specifies a received signal quality threshold (e.g., in decibels) for the not-at-cell-edge criterion.

At 403, the UE 100 enters an RRM relaxation state due to at least one RRM relaxation trigger associated with the one or more RRM relaxation parameters being fulfilled. The at least one RRM relaxation trigger may comprise at least one of: the low-mobility criterion, the stationarity criterion, or the not-at-cell edge criterion. For example, the UE 100 may fulfill the not-at-cell-edge criterion due to moving in the cell 121. In the RRM relaxation state, the UE 100 performs less frequent measurements (e.g., RSRP and/or RSRQ measurements) of one or more neighboring cells 122, 123, 124, and the UE 100 may delay cell re-selection due to the less frequent measurements.

At 404, the UE 100 logs information related to the RRM relaxation state of the UE 100 based on entering the RRM relaxation state.

For example, before or upon entering the RRM relaxation state, the UE 100 may log one or more radio measurements (e.g., RSRP and/or RSRQ) of the serving cell 121 and/or one or more radio measurements (e.g., RSRP and/or RSRQ) of the one or more neighboring cells 122, 123, 124 that were obtained before entering the RRM relaxation state in the serving cell 121. In other words, the UE 100 may log the last measurements of the serving cell 121 and the one or more neighboring cells 122, 123, 124. The serving cell 121 may also be referred to as a source cell herein. The last cell measurements may be a trace of measurements that are collected over a certain period of time.

Alternatively, or additionally, the UE 100 may log the time of entering the RRM relaxation state.

Alternatively, or additionally, the UE 100 may log the at least one RRM relaxation trigger that was fulfilled and thus caused entering the RRM relaxation state.

At 405, if the UE is in idle (RRC_IDLE) mode, the UE 100 transmits an RRC setup request message to the source network node 104 controlling the cell 121 that the UE 100 is camping on. With the RRC setup request message, the UE 100 requests the establishment of an RRC connection with the source network node 104.

At 406, the RRC connection establishment fails, as the UE 100 is too far away from the serving cell 121, and thus the source network node 104 cannot decode the RRC setup request message.

At 407, the UE 100 performs a cell re-selection procedure, but it ends up re-selecting the same serving cell 121 controlled by the source network node 104.

At 408, the UE 100 disables the RRM relaxation function based on re-selecting the same serving cell 121 within a pre-defined time limit after the connection establishment failure in the serving cell 121. Disabling the RRM relaxation function means that the UE 100 cannot enter the RRM relaxation state, while the RRM relaxation function is disabled.

At 409, the UE 100 may exit the RRM relaxation state due to disabling the RRM relaxation function.

At 410, the UE 100 may log information related to the RRM relaxation state of the UE 100 based on exiting the RRM relaxation state. For example, the UE 100 may log the time of exiting the RRM relaxation state. Alternatively, or additionally, the UE 100 may log the duration of being in the RRM relaxation state.

After exiting the RRM relaxation state, the UE 100 may continue the measurements.

At 411, the UE 100 generates a message (called RRM relaxation report herein) comprising the logged information related to the RRM relaxation state, wherein the message is generated based on the RRC connection establishment failure of the UE 100 in the idle mode or in the inactive mode and based on exiting the RRM relaxation state.

For example, the information in the RRM relaxation report may comprise at least one of: the time of entering the RRM relaxation state, the time of exiting the RRM relaxation state, the duration of the RRM relaxation state, the at least one RRM relaxation trigger that caused entering the RRM relaxation state, the identity of the serving cell 121 on which the one or more RRM relaxation parameters used for evaluating the at least one RRM relaxation trigger were obtained, or the one or more RRM relaxation parameters used for evaluating the at least one RRM relaxation trigger.

The RRM relaxation report may further comprise: the one or more radio measurements of the serving cell 121 that were obtained before entering the RRM relaxation state in the serving cell 121, the one or more radio measurements of the one or more neighboring cells 122, 123, 124 that were obtained before entering the RRM relaxation state in the serving cell 121, and information related to the connection establishment failure in the serving cell 121.

The RRM relaxation report may further comprises an indication indicating the disabling of the RRM relaxation function.

At 412, the UE 100 performs a cell re-selection procedure to re-select to a neighboring cell 122 controlled by a target network node 104B. For example, the cell re-selection procedure of 412 may be based on new measurements of the source cell 121 and the one or more neighboring cells 122, 123, 124 that are obtained during the RRM relaxation state or after exiting the RRM relaxation state.

At 413, if the UE is in idle (RRC_IDLE) mode, the UE 100 transmits an RRC setup request message to the target network node 104B controlling the neighboring cell 122. The RRC setup request message transmitted to the target network node 104B indicates availability of the logged measurements of the serving cell 121 and the one or more neighboring cells 122, 123, 124. The target network node 104B receives the RRC setup request message from the UE 100.

At 414, the target network node 104B transmits an UE information request message to the UE 100 to request the UE 100 to report the measurements.

At 415, in response to receiving the UE information request message, the UE 100 transmits an UE information response message to the target network node 104B, wherein the UE information response message comprises a connection establishment failure report (ConnEstFailReport) message comprising the RRM relaxation report. In other words, the RRM relaxation report is transmitted based at least on performing the cell re-selection to the neighboring cell 122. The target network node 104B receives the UE information response message.

The target network node 104B may forward the connection establishment failure report to the source network node 104 controlling the source cell 121.

The source network node 104 may adjust or optimize, based at least partly on the information in the RRM relaxation report, the one or more RRM relaxation parameters associated with triggering the RRM relaxation state.

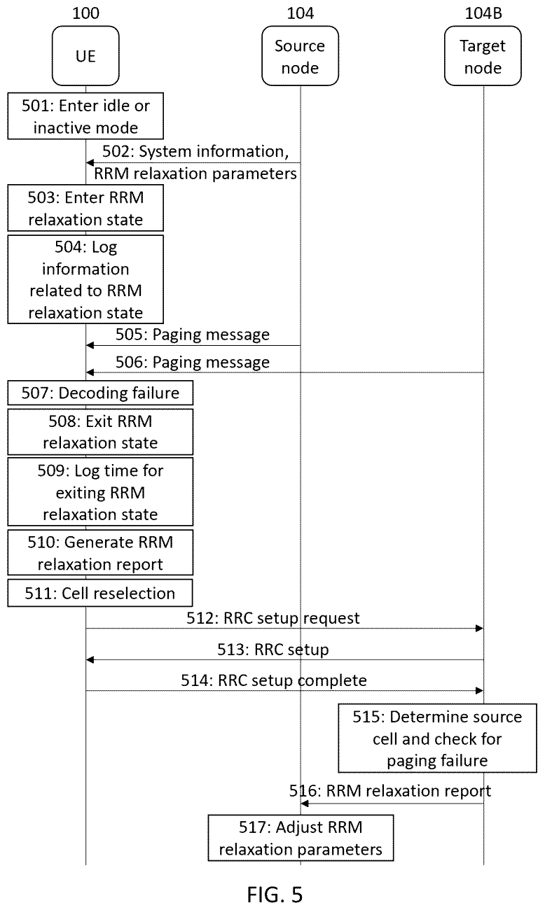

FIG. 5 illustrates a signal flow diagram according to an example embodiment for solving the paging failure issue. The UE may indicate to the target network node whether it was in RRM relaxation state after it re-selects a new cell. If the new cell is served by a new network node, the new network node may inform the neighbor network nodes or the AMF related to the possibility that the UE may have missed receiving a paging message. The AMF and the network nodes may use this information to re-initiate paging or a RAN paging procedure. This example embodiment may enable the network to perform closed-loop optimization of the RRM relaxation parameters, and thus help to minimize paging failures caused by the misconfiguration of the RRM relaxation parameters.

Referring to FIG. 5, at 501, the UE 100 enters idle (RRC_IDLE) mode or inactive (RRC_INACTIVE) mode. The UE 100 may be a reduced capability (RedCap) device or any other type of UE.

At 502, a source network node 104 transmits, or broadcasts, system information comprising one or more radio resource management (RRM) relaxation parameters on a cell 121 controlled by the source network node 104. The UE 100 receives the system information from the source network node 104 on the cell 121 that the UE 100 is currently camping on.

For example, the one or more RRM relaxation parameters may comprise at least one of: S_SearchDeltaP, T_SearchDeltaP, S_SearchThresholdP, or S_SearchThresholdQ.

S_SearchDeltaP specifies a threshold (e.g., in decibels) on the received signal level variation for the low-mobility criterion.

T_SearchDeltaP specifies the time period over which the received signal level variation is evaluated for the low-mobility criterion.

S_SearchThresholdP specifies a received signal level threshold (e.g., in decibels) for the not-at-cell-edge criterion.

S_SearchThresholdQ specifies a received signal quality threshold (e.g., in decibels) for the not-at-cell-edge criterion.

At 503, the UE 100 enters an RRM relaxation state due to at least one RRM relaxation trigger associated with the one or more RRM relaxation parameters being fulfilled. The at least one RRM relaxation trigger may comprise at least one of: the low-mobility criterion, the stationarity criterion, or the not-at-cell edge criterion. For example, the UE 100 may fulfill the not-at-cell-edge criterion due to moving in the cell 121. In the RRM relaxation state, the UE 100 performs less frequent measurements (e.g., RSRP and/or RSRQ measurements) of one or more neighboring cells 122, 123, 124, and the UE 100 may delay cell re-selection due to the less frequent measurements.

At 504, the UE 100 logs information related to the RRM relaxation state of the UE 100 based on entering the RRM relaxation state.

For example, before or upon entering the RRM relaxation state, the UE 100 may log one or more radio measurements (e.g., RSRP and/or RSRQ) of the serving cell 121 and/or one or more radio measurements (e.g., RSRP and/or RSRQ) of the one or more neighboring cells 122, 123, 124 that were obtained before entering the RRM relaxation state in the serving cell 121. In other words, the UE 100 may log the last measurements of the serving cell 121 and the one or more neighboring cells 122, 123, 124. The serving cell 121 may also be referred to as a source cell herein. The last cell measurements may be a trace of measurements that are collected over a certain period of time.

Alternatively, or additionally, the UE 100 may log the time of entering the RRM relaxation state.

Alternatively, or additionally, the UE 100 may log the at least one RRM relaxation trigger that was fulfilled and thus caused entering the RRM relaxation state.

At 505, the source network node 104 transmits a paging message to the UE 100. The source network node 104 may store information indicating the time when it transmitted the paging message.

At 506, another network node 104B controlling another cell 122 within the registration area of the UE 100 transmits a paging message to the UE 100. The network node 104B may store information indicating the time when it transmitted the paging message.

In other words, at 505 and 506, the network pages the UE 100 within the registration area of the UE 100, while the UE is in the RRM relaxation state.

At 507, the UE 100 fails to decode the paging messages (e.g., because the UE is too far away from the serving cell 121, and because the UE is not monitoring the paging occasions of the other cell 122). For example, the UE 100 may miss the paging due to failure of decoding the downlink control information (DCI) related to the paging message. As another example, the UE 100 may decode the DCI, but not the PDSCH carrying the paging message that is directed to the UE 100.

At 508, the UE 100 may exit the RRM relaxation state. For example, the at least one RRM relaxation trigger may not be fulfilled anymore due to the UE 100 moving in the cell 121 (e.g., due to moving to the cell edge).

Alternatively, the UE 100 may remain in the RRM relaxation state until the UE enters connected mode (e.g., until 512).

At 509, the UE 100 may log information related to the RRM relaxation state of the UE 100 based on exiting the RRM relaxation state. For example, the UE 100 may log the time of exiting the RRM relaxation state. Alternatively, or additionally, the UE 100 may log the duration of being in the RRM relaxation state.

After exiting the RRM relaxation state, the UE 100 may continue the measurements.

At 510, the UE 100 generates a message (called RRM relaxation report herein) comprising the logged information related to the RRM relaxation state, wherein the message is generated based on the paging failure of the UE 100 in the idle mode or in the inactive mode.

For example, the information in the RRM relaxation report may comprise at least one of: the time of entering the RRM relaxation state, the time of exiting the RRM relaxation state, the duration of the RRM relaxation state, the at least one RRM relaxation trigger that caused entering the RRM relaxation state, the identity of the serving cell 121 on which the one or more RRM relaxation parameters used for evaluating the at least one RRM relaxation trigger were obtained, the one or more RRM relaxation parameters used for evaluating the at least one RRM relaxation trigger, the one or more radio measurements of the serving cell 121 that were obtained before entering the RRM relaxation state in the serving cell 121, or the one or more radio measurements of the one or more neighboring cells 122, 123, 124 that were obtained before entering the RRM relaxation state in the serving cell 121.

It should be noted that the source network node 104 may store the one or more RRM relaxation parameters configured to the UE 100 at 502 (e.g., in a log). In this case, the UE 100 does not need to include the one or more RRM relaxation parameters in the RRM relaxation report, since they are already known by the source network node 104.

At 511, the UE 100 performs a cell re-selection procedure to re-select to a neighboring cell 122 controlled by the target network node 104B. For example, the cell re-selection may be based on new measurements of the serving cell 121 and the one or more neighboring cells 122, 123, 124 that are obtained during the RRM relaxation state or after exiting the RRM relaxation state.

At 512, if the UE is in idle (RRC_IDLE) mode, the UE 100 transmits an RRC setup request message to the target network node 104B controlling the neighboring cell 122. The target network node 104B receives the RRC setup request message from the UE 100.

At 513, the target network node 104B transmits an RRC setup message to the UE 100 to set up the connection between the UE 100 and the target network node 104B.

At 514, the UE 100 transmits, to the target network node 104B, an RRC setup complete message to indicate that the connection between the UE 100 and the target network node 104B was successfully established, wherein the RRC setup complete message comprises the RRM relaxation report. In other words, the RRM relaxation report is transmitted based at least on performing the cell re-selection to the neighboring cell 122. The target network node 104B receives the RRC setup complete message.

The RRC setup complete message may further comprise an indication indicating whether a paging message was received by the UE 100 within a pre-defined time duration before setting up the connection to the target network node 104B or before exiting the RRM relaxation state. In this example, the indication may indicate that a paging message was not received by the UE 100 within the pre-defined time duration before setting up the connection or before exiting the RRM relaxation state. The pre-defined time duration may be configured to the UE 100 by the network (e.g., by the source network node 104).

For example, the UE 100 may transmit this indication to the target network node 104B, if the new cell 122 belongs to the same registration area (RA) or RAN notification area as that of the source cell 121. If the indication is transmitted to a cell out of the RA, then the cell may forward this information to one or more network nodes in the RA of the UE 100.

Alternatively, or additionally, the UE 100 may report failure in decoding the PDSCH for paging after receiving a paging indication in a physical downlink control channel (PDCCH). The network may use this information to deduce that paging decoding failure happened before cell re-selection in the cell 121 that the UE 100 was previously camping on. It can also be used to adjust or fine-tune the RRM relaxation parameters.

At 515, the target network node 104B determines, based on the information in the RRM relaxation report, the identity of the source cell 121 in which the UE 100 experienced the RRM relaxation state. For example, the identity of the source cell 121 may be included in the RRM relaxation report, and the target network node 104B may then map the identity of the source cell 121 to the source network node 104 controlling the source cell 121.

The target network node 104B may also determine whether the target network node 104B transmitted the paging message to the UE 100 (at 506) within the pre-defined time duration before the connection between the UE 100 and the target network node 104B was set up or before the UE 100 exited the RRM relaxation state. The target network node 104B may forward the RRM relaxation report to the source network node 104 based on determining that the target network node 104B transmitted the paging message to the UE 100 within the pre-defined time duration (but the UE 100 failed to receive the paging message). In other words, if the UE 100 indicates to the target network node 104B that it did not receive any paging message over the pre-defined time duration, even though the target network node 104B transmitted the paging message during the pre-defined time duration, then the target network node 104B may inform the source network node 104 (or AMF) if the UE 100 was supposed to receive a paging message during the pre-defined time duration.

Alternatively, in case the target network node 104B did not transmit a paging message to the UE 100 at 506, then the target network node 104B may forward the RRM relaxation report (related to paging failure) directly to the source network node 104, after decoding the source cell identifier.

At 516, based on the determination, the target network node 104B forwards the connection establishment failure report to the source network node 104 controlling the source cell 121. The source network node 104 receives the connection establishment failure report comprising the RRM relaxation report.

At 517, the source network node 104 adjusts or optimizes, based at least partly on the information in the RRM relaxation report, the one or more RRM relaxation parameters associated with triggering the RRM relaxation state. The source network node 104 may collect RRM relaxation reports from multiple UEs before performing the adjustment or optimization.

For example, the source network node 104 may perform the adjustment or optimization, if the UE 100 indicated that it did not receive any paging message during the pre-defined time duration, even though the target network node 104B transmitted the paging message to the UE 100 during the pre-defined time duration.

In case the UE 100 was not paged by the target network node 104B during the pre-defined time duration, then the source network node 104 may determine whether the source network node 104 transmitted the paging message to the UE 100 (at 505) within the pre-defined time duration before the connection between the UE 100 and the target network node 104B was set up or before the UE 100 exited the RRM relaxation state. In other words, the source network node 104 may determine if the UE 100 has been paged during the pre-defined time duration for which the UE reported that it did not receive any paging messages. The one or more RRM relaxation parameters may be adjusted based on determining that the source network node 104 transmitted the paging message to the UE 100 within the pre-defined time duration (i.e., if the UE has been paged on the serving cell 121 during the pre-defined time duration, a paging failure is decided and the RRM parameters are optimized). If the UE has not been paged, then no failure is defined and no optimization needs to be done.

For example, the source network node 104 may use self-organizing network (SON) mechanisms or artificial intelligence or machine learning techniques to optimize the one or more RRM relaxation parameters.

The source network node 104 may transmit the adjusted one or more RRM relaxation parameters to one or more other UEs 102 in the source cell 121 (e.g., in system information). The adjusted one or more RRM relaxation parameters may not be transmitted to the UE 100, since the UE 100 is no longer in the source cell 121. However, if the UE 100 re-selects back to the source cell 121, then the UE 100 may receive the adjusted one or more RRM relaxation parameters from the source network node 104.

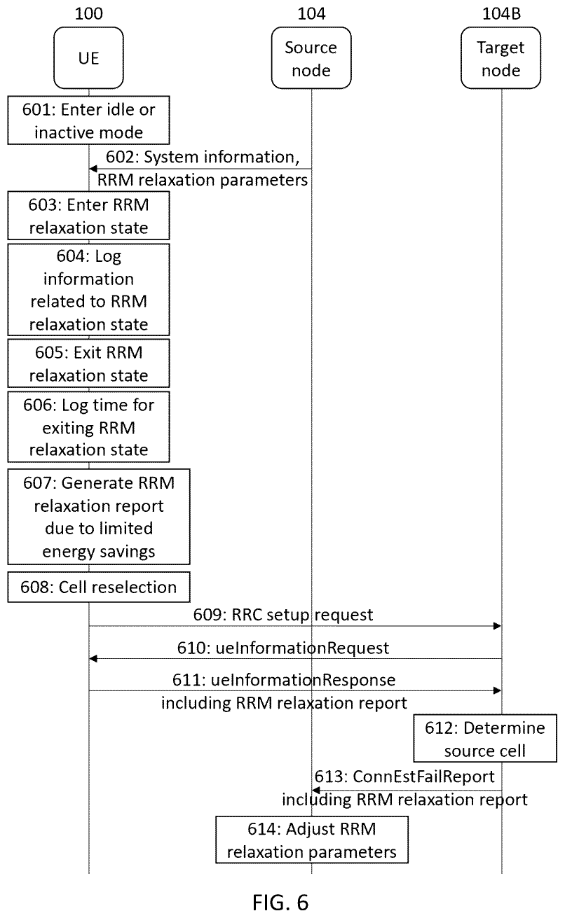

FIG. 6 illustrates a signal flow diagram according to an example embodiment for solving the energy consumption issue. The UE may compile an RRM relaxation report that is transmitted to the network or fetched by the network during or after connection setup, for example. The RRM relaxation report may indicate the amount of energy saved while the UE is in RRM relaxation state. The RRM relaxation report may also indicate, for example, the duration of the RRM relaxation state and measurements related to the RRM relaxation.

Referring to FIG. 6, at 601, the UE 100 enters idle (RRC_IDLE) mode or inactive (RRC_INACTIVE) mode. The UE 100 may be a reduced capability (RedCap) device or any other type of UE.

The UE 100 may be configured by the network to do RRM relaxation reporting, for instance, using an RRC Release message (releasing the connection of the UE 100 or moving the connection to RRC idle or inactive mode) to log information related to the RRM relaxation state, while being in idle or inactive mode.

At 602, a source network node 104 transmits, or broadcasts, system information comprising one or more radio resource management (RRM) relaxation parameters on a cell 121 controlled by the source network node 104. The UE 100 receives the system information from the source network node 104 on the cell 121 that the UE 100 is currently camping on.

For example, the one or more RRM relaxation parameters may comprise at least one of: S_SearchDeltaP, T_SearchDeltaP, S_SearchThresholdP, or S_SearchThresholdQ.

S_SearchDeltaP specifies a threshold (e.g., in decibels) on the received signal level variation for the low-mobility criterion.

T_SearchDeltaP specifies the time period over which the received signal level variation is evaluated for the low-mobility criterion.

S_SearchThresholdP specifies a received signal level threshold (e.g., in decibels) for the not-at-cell-edge criterion.

S_SearchThresholdQ specifies a received signal quality threshold (e.g., in decibels) for the not-at-cell-edge criterion.

At 603, the UE 100 enters an RRM relaxation state due to at least one RRM relaxation trigger associated with the one or more RRM relaxation parameters being fulfilled. The at least one RRM relaxation trigger may comprise at least one of: the low-mobility criterion, the stationarity criterion, or the not-at-cell edge criterion. For example, the UE 100 may fulfill the not-at-cell-edge criterion due to moving in the cell 121. In the RRM relaxation state, the UE 100 performs less frequent measurements (e.g., RSRP and/or RSRQ measurements) of one or more neighboring cells 122, 123, 124, and the UE 100 may delay cell re-selection due to the less frequent measurements.

At 604, the UE 100 logs information related to the RRM relaxation state of the UE 100 based on entering the RRM relaxation state.

For example, before or upon entering the RRM relaxation state, the UE 100 may log one or more radio measurements (e.g., RSRP and/or RSRQ) of the serving cell 121 and/or one or more radio measurements (e.g., RSRP and/or RSRQ) of the one or more neighboring cells 122, 123, 124 that were obtained before entering the RRM relaxation state in the serving cell 121. In other words, the UE 100 may log the last measurements of the serving cell 121 and the one or more neighboring cells 122, 123, 124. The serving cell 121 may also be referred to as a source cell herein. The last cell measurements may be a trace of measurements that are collected over a certain period of time.

Alternatively, or additionally, the UE 100 may log the time of entering the RRM relaxation state.

Alternatively, or additionally, the UE 100 may log the at least one RRM relaxation trigger that was fulfilled and thus caused entering the RRM relaxation state.

At 605, the UE 100 may exit the RRM relaxation state. For example, the at least one RRM relaxation trigger may not be fulfilled anymore due to the UE 100 moving in the cell 121 (e.g., due to moving to the cell edge).

Alternatively, the UE 100 may remain in the RRM relaxation state until the UE enters connected mode (e.g., until 609).

At 606, the UE 100 may log information related to the RRM relaxation state of the UE 100 based on exiting the RRM relaxation state. For example, the UE 100 may log the time of exiting the RRM relaxation state. Alternatively, or additionally, the UE 100 may log the duration of being in the RRM relaxation state.

After exiting the RRM relaxation state, the UE 100 may continue the measurements.

At 607, the UE 100 generates a message (called RRM relaxation report herein) comprising the logged information related to the RRM relaxation state, wherein the message is generated based on an energy savings status associated with the RRM relaxation state.

For example, the message may be generated based on the amount of energy saved in the RRM relaxation state being below a first threshold, or the duration of the RRM relaxation state being below a second threshold. The first threshold and/or the second threshold may be configured to the UE 100 by the source network node 104, for example. In other words, the UE 100 may be configured by the network to transmit the RRM relaxation report, if the time duration for which RRM relaxation has been applied is too short or below a threshold that is set by the network, or if the energy saved by the UE is minimal (e.g., below the first threshold). It can be left for UE implementation to determine if the energy saved was minimal or not.

Herein the terms “first threshold” and “second threshold” are used to distinguish the thresholds, and they do not necessarily mean a specific order of the thresholds.

For example, the information in the RRM relaxation report may comprise at least one of: the time of entering the RRM relaxation state, the time of exiting the RRM relaxation state, the duration of the RRM relaxation state, the at least one RRM relaxation trigger that caused entering the RRM relaxation state, the identity of the serving cell 121 on which the one or more RRM relaxation parameters used for evaluating the at least one RRM relaxation trigger were obtained, the one or more RRM relaxation parameters used for evaluating the at least one RRM relaxation trigger, the one or more radio measurements of the serving cell 121 that were obtained before entering the RRM relaxation state in the serving cell 121, or the one or more radio measurements of the one or more neighboring cells 122, 123, 124 that were obtained before entering the RRM relaxation state in the serving cell 121.

It should be noted that the source network node 104 may store the one or more RRM relaxation parameters configured to the UE 100 at 602 (e.g., in a log). In this case, the UE 100 does not need to include the one or more RRM relaxation parameters in the RRM relaxation report, since they are already known by the source network node 104.

The RRM relaxation report may further comprise information indicating the amount of energy saved in the RRM relaxation state.

At 608, the UE 100 performs a cell re-selection procedure to re-select to a neighboring cell 122 controlled by a target network node 104B. For example, the cell re-selection may be based on new measurements of the serving cell 121 and the one or more neighboring cells 122, 123, 124 that are obtained during the RRM relaxation state or after exiting the RRM relaxation state.

At 609, if the UE is in idle (RRC_IDLE) mode, the UE 100 transmits an RRC setup request message to the target network node 104B controlling the neighboring cell 122. The RRC setup request message transmitted to the target network node 104B indicates availability of the logged measurements of the serving cell 121 and the one or more neighboring cells 122, 123, 124. The target network node 104B receives the RRC setup request message from the UE 100.

At 610, the target network node 104B transmits an UE information request message to the UE 100 to request the UE 100 to report the measurements.

At 611, in response to receiving the UE information request message, the UE 100 transmits an UE information response message to the target network node 104B, wherein the UE information response message comprises a connection establishment failure report (ConnEstFailReport) message comprising the RRM relaxation report. In other words, the RRM relaxation report is transmitted based at least on performing the cell re-selection to the neighboring cell 122. The target network node 104B receives the UE information response message.

At 612, the target network node 104B determines, based on the information in the RRM relaxation report, the identity of the source cell 121 in which the UE 100 experienced the RRM relaxation state. For example, the identity of the source cell 121 may be included in the RRM relaxation report, and the target network node 104B may then map the identity of the source cell 121 to the source network node 104 controlling the source cell 121.

At 613, based on the determination, the target network node 104B forwards the connection establishment failure report to the source network node 104 controlling the source cell 121. The source network node 104 receives the connection establishment failure report comprising the RRM relaxation report.

At 614, the source network node 104 adjusts or optimizes, based at least partly on the information in the RRM relaxation report, the one or more RRM relaxation parameters associated with triggering the RRM relaxation state. The source network node 104 may collect RRM relaxation reports from multiple UEs before performing the adjustment or optimization.

For example, the source network node 104 may use self-organizing network (SON) mechanisms or artificial intelligence or machine learning techniques to optimize the one or more RRM relaxation parameters.

The source network node 104 may transmit the adjusted one or more RRM relaxation parameters to one or more other UEs 102 in the source cell 121 (e.g., in system information). The adjusted one or more RRM relaxation parameters may not be transmitted to the UE 100, since the UE 100 is no longer in the source cell 121. However, if the UE 100 re-selects back to the source cell 121, then the UE 100 may receive the adjusted one or more RRM relaxation parameters from the source network node 104.

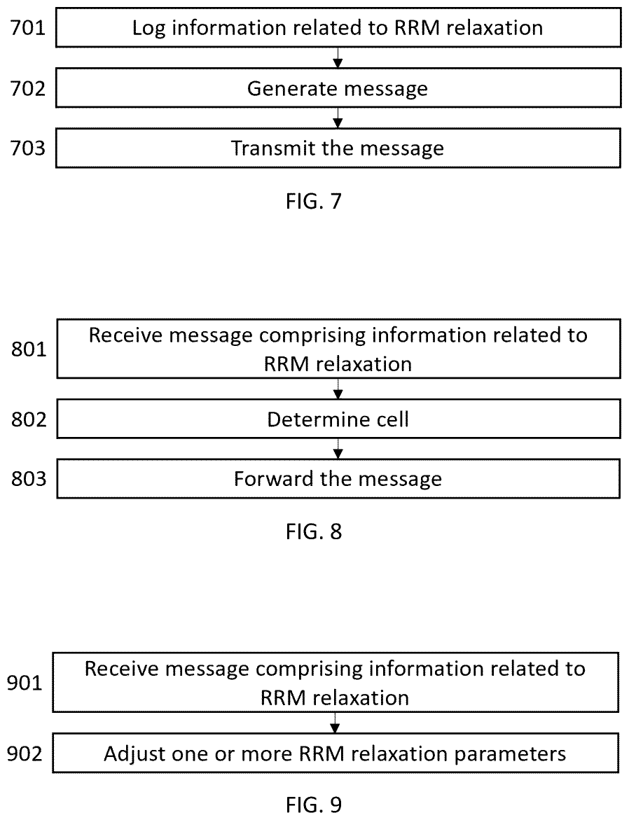

FIG. 7 illustrates a flow chart according to an example embodiment of a method performed by an apparatus 1000. For example, the apparatus 1000 may be, or comprise, or be comprised in, a user equipment (UE) 100, 102. The UE 100, 102 may be a reduced capability (RedCap) device or any other type of UE.

Referring to FIG. 7, in block 701, the apparatus 1000 logs information related to a radio resource management relaxation state of the apparatus 1000.

The information may be logged based on entering and/or exiting the radio resource management relaxation state.

In block 702, the apparatus 1000 generates a message comprising the information, wherein the message is generated based on a failure or a status of the apparatus 1000 in an idle mode or in an inactive mode.

The failure may comprise one of: a radio resource control connection establishment failure or a paging failure. The status may comprise an energy savings status associated with the radio resource management relaxation state.

In block 703, the apparatus transmits the message. The message may be transmitted based at least on performing a cell re-selection from a source cell 121 to a target cell 122. The message may be transmitted to a target network node 104B controlling the target cell 122 of the cell re-selection. The source cell 121 may also be referred to as a serving cell herein.

The information may comprise at least one of: a time of entering the radio resource management relaxation state, a time of exiting the radio resource management relaxation state, a duration of the radio resource management relaxation state, at least one trigger that caused entering the radio resource management relaxation state, an identity of the serving cell 121 on which one or more radio resource management relaxation parameters used for evaluating the at least one trigger were obtained, or the one or more radio resource management relaxation parameters used for evaluating the at least one trigger.

The message may further comprise: one or more radio measurements of the serving cell that were obtained before entering the radio resource management relaxation state in the serving cell 121, one or more radio measurements of one or more neighboring cells 122, 123, 124 that were obtained before entering the radio resource management relaxation state in the serving cell 121, and information related to a connection establishment failure in the serving cell 121.

The apparatus 1000 may disable a radio resource management relaxation function based on re-selecting the serving cell 121 within a pre-defined time limit after the failure in the serving cell 121 (e.g., radio resource control connection establishment failure or paging failure); and exit the radio resource management relaxation state based on re-selecting the serving cell 121 within the pre-defined time limit after the failure in the serving cell 121. In this case, the message may further comprise an indication indicating the disabling of the radio resource management relaxation function.

Alternatively, or additionally, the message may further comprise an indication indicating whether a paging message was received within a pre-defined time duration before setting up a connection or before exiting the radio resource management relaxation state.

Alternatively, or additionally, the message may further comprise information indicating an amount of energy saved in the radio resource management relaxation state.

In case the message is generated based on the energy savings status, then the message may be generated based on at least one of: the amount of energy saved being below a first threshold, or the duration of the radio resource management relaxation state being below a second threshold.

FIG. 8 illustrates a flow chart according to an example embodiment of a method performed by an apparatus 1100. For example, the apparatus 1100 may be, or comprise, or be comprised in, a network node (e.g., the target network node 104B) of a radio access network.

Referring to FIG. 8, in block 801, the apparatus 1100 receives, from a user equipment 100, a message comprising information related to a radio resource management relaxation state of the user equipment 100, wherein the message is based on a failure or a status of the user equipment 100 in an idle mode or in an inactive mode.

The failure may comprise one of: a radio resource control connection establishment failure or a paging failure. The status may comprise an energy savings status associated with the radio resource management relaxation state.

The information may comprise at least one of: a time of entering the radio resource management relaxation state, a time of exiting the radio resource management relaxation state, a duration of the radio resource management relaxation state, at least one trigger that caused entering the radio resource management relaxation state, an identity of a cell 121 on which one or more radio resource management relaxation parameters used for evaluating the at least one trigger were obtained, or the one or more radio resource management relaxation parameters used for evaluating the at least one trigger.

In block 802, the apparatus 1100 determines, based on the information, a cell 121 in which the user equipment 100 experienced the radio resource management relaxation state. For example, the identity of the cell 121 may be included in the information, and the apparatus may map the identity of the cell 121 to a network node 104 controlling the cell 121.

In block 803, based on the determination, the apparatus 1100 forwards the message to the network node 104 controlling the cell 121.

The message may further comprise: one or more radio measurements of the cell 121 that were obtained before entering the radio resource management relaxation state in the cell 121, one or more radio measurements of one or more neighboring cells 122, 123, 124 that were obtained before entering the radio resource management relaxation state in the cell 121, and information related to a connection establishment failure in the cell 121.

The message may further comprise an indication indicating a disabling of the radio resource management relaxation function.

Alternatively, or additionally, the message may further comprise information indicating an amount of energy saved in the radio resource management relaxation state.

Alternatively, or additionally, the message may further comprise an indication indicating whether a paging message was received by the user equipment 100 within a pre-defined time duration before setting up a connection or before exiting the radio resource management relaxation state.

For example, the message may comprise an indication indicating that a paging message was not received by the user equipment 100 within a pre-defined time duration before setting up the connection or before exiting the radio resource management relaxation state. In this case, the apparatus 1100 may determine whether the apparatus 1100 transmitted the paging message to the user equipment 100 within the pre-defined time duration, wherein the message may be forwarded to the network node 104 based on determining that the apparatus 1100 transmitted the paging message to the user equipment 100 within the pre-defined time duration.

FIG. 9 illustrates a flow chart according to an example embodiment of a method performed by an apparatus 1100. For example, the apparatus 1100 may be, or comprise, or be comprised in, a network node (e.g., the source network node 104) of a radio access network.

Referring to FIG. 9, in block 901, the apparatus 1100 receives a message comprising information related to a radio resource management relaxation state of a user equipment 100, wherein the message is based on a failure or a status of the user equipment 100 in an idle mode or in an inactive mode.

The failure may comprise one of: a radio resource control connection establishment failure or a paging failure. The status may comprise an energy savings status associated with the radio resource management relaxation state.

The information may comprise at least one of: a time of entering the radio resource management relaxation state, a time of exiting the radio resource management relaxation state, a duration of the radio resource management relaxation state, at least one trigger that caused entering the radio resource management relaxation state, an identity of a cell 121 on which one or more radio resource management relaxation parameters used for evaluating the at least one trigger were obtained, or the one or more radio resource management relaxation parameters used for evaluating the at least one trigger.

In block 902, the apparatus 1100 adjusts, based at least partly on the information, one or more radio resource management relaxation parameters associated with triggering the radio resource management relaxation state.

The message may further comprise: one or more radio measurements of the cell 121 that were obtained before entering the radio resource management relaxation state in the cell 121, one or more radio measurements of one or more neighboring cells 122, 123, 124 that were obtained before entering the radio resource management relaxation state in the cell 121, and information related to a connection establishment failure in the cell 121.

The message may further comprise an indication indicating a disabling of the radio resource management relaxation function.

Alternatively, or additionally, the message may further comprise information indicating an amount of energy saved in the radio resource management relaxation state.

Alternatively, or additionally, the message may further comprise an indication indicating whether a paging message was received by the user equipment 100 within a pre-defined time duration before setting up a connection or before exiting the radio resource management relaxation state.

For example, the message may comprise an indication indicating that a paging message was not received by the user equipment 100 within a pre-defined time duration before setting up a connection or before exiting the radio resource management relaxation state. In this case, the apparatus 1100 may determine whether the apparatus 1100 transmitted the paging message to the user equipment 100 within the pre-defined time duration, wherein the one or more radio resource management relaxation parameters may be adjusted based on determining that the apparatus 1100 transmitted the paging message to the user equipment 100 within the pre-defined time duration.

The blocks, related functions, and information exchanges (messages) described above by means of FIGS. 3-9 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

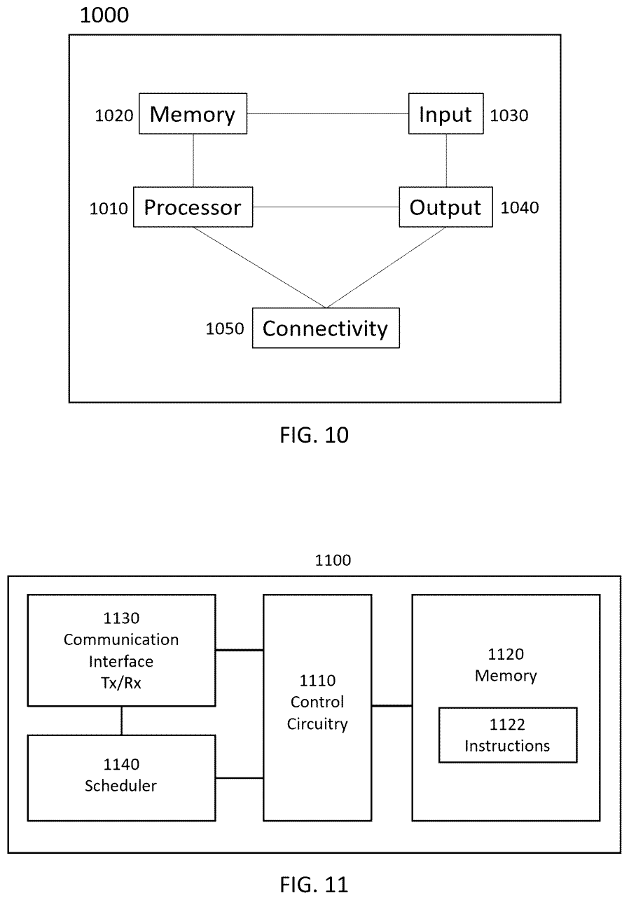

FIG. 10 illustrates an example of an apparatus 1000 comprising means for performing one or more of the example embodiments described above. For example, the apparatus 1000 may be an apparatus such as, or comprising, or comprised in, a user equipment (UE) 100, 102. The user equipment may also be called a wireless communication device, a subscriber unit, a mobile station, a remote terminal, an access terminal, a user terminal, a terminal device, or a user device.

The apparatus 1000 may comprise a circuitry or a chipset applicable for realizing one or more of the example embodiments described above. For example, the apparatus 1000 may comprise at least one processor 1010. The at least one processor 1010 interprets instructions (e.g., computer program instructions) and processes data. The at least one processor 1010 may comprise one or more programmable processors. The at least one processor 1010 may comprise programmable hardware with embedded firmware and may, alternatively or additionally, comprise one or more application-specific integrated circuits (ASICs).

The at least one processor 1010 is coupled to at least one memory 1020. The at least one processor is configured to read and write data to and from the at least one memory 1020. The at least one memory 1020 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 1020 stores computer readable instructions that are executed by the at least one processor 1010 to perform one or more of the example embodiments described above. For example, non-volatile memory stores the computer readable instructions, and the at least one processor 1010 executes the instructions using volatile memory for temporary storage of data and/or instructions. The computer readable instructions may refer to computer program code.

The computer readable instructions may have been pre-stored to the at least one memory 1020 or, alternatively or additionally, they may be received, by the apparatus, via an electromagnetic carrier signal and/or may be copied from a physical entity such as a computer program product. Execution of the computer readable instructions by the at least one processor 1010 causes the apparatus 1000 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1000 may further comprise, or be connected to, an input unit 1030. The input unit 1030 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1030 may comprise an interface to which external devices may connect to.

The apparatus 1000 may also comprise an output unit 1040. The output unit may comprise or be connected to one or more displays capable of rendering visual content, such as a light emitting diode (LED) display, a liquid crystal display (LCD) and/or a liquid crystal on silicon (LCOS) display. The output unit 1040 may further comprise one or more audio outputs. The one or more audio outputs may be for example loudspeakers.

The apparatus 1000 further comprises a connectivity unit 1050. The connectivity unit 1050 enables wireless connectivity to one or more external devices. The connectivity unit 1050 comprises at least one transmitter and at least one receiver that may be integrated to the apparatus 1000 or that the apparatus 1000 may be connected to. The at least one transmitter comprises at least one transmission antenna, and the at least one receiver comprises at least one receiving antenna. The connectivity unit 1050 may comprise an integrated circuit or a set of integrated circuits that provide the wireless communication capability for the apparatus 1000. Alternatively, the wireless connectivity may be a hardwired application-specific integrated circuit (ASIC). The connectivity unit 1050 may also provide means for performing at least some of the blocks or functions of one or more example embodiments described above. The connectivity unit 1050 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1000 may further comprise various components not illustrated in FIG. 10. The various components may be hardware components and/or software components.

FIG. 11 illustrates an example of an apparatus 1100 comprising means for performing one or more of the example embodiments described above. For example, the apparatus 1100 may be an apparatus such as, or comprising, or comprised in, a network node 104, 104A of a radio access network.

The network node may also be referred to, for example, as a network element, a radio access network (RAN) node, a source network node, a target network node, a next generation radio access network (NG-RAN) node, a NodeB, an eNB, a gNB, a base transceiver station (BTS), a base station, an NR base station, a 5G base station, an access node, an access point (AP), a cell site, a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1100 may comprise, for example, a circuitry or a chipset applicable for realizing one or more of the example embodiments described above. The apparatus 1100 may be an electronic device comprising one or more electronic circuitries. The apparatus 1100 may comprise a communication control circuitry 1110 such as at least one processor, and at least one memory 1120 storing instructions 1122 which, when executed by the at least one processor, cause the apparatus 1100 to carry out one or more of the example embodiments described above. Such instructions 1122 may, for example, include computer program code (software). The at least one processor and the at least one memory storing the instructions may provide the means for providing or causing the performance of any of the methods and/or blocks described above.

The processor is coupled to the memory 1120. The processor is configured to read and write data to and from the memory 1120. The memory 1120 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1120 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 1120 or, alternatively or additionally, they may be received, by the apparatus, via an electromagnetic carrier signal and/or may be copied from a physical entity such as a computer program product. Execution of the computer readable instructions causes the apparatus 1100 to perform one or more of the functionalities described above.

The memory 1120 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbor cell list, and, in some example embodiments, structures of frames used in the detected neighbor cells.

The apparatus 1100 may further comprise or be connected to a communication interface 1130, such as a radio unit, comprising hardware and/or software for realizing communication connectivity with one or more wireless communication devices according to one or more communication protocols. The communication interface 1130 comprises at least one transmitter (Tx) and at least one receiver (Rx) that may be integrated to the apparatus 1100 or that the apparatus 1100 may be connected to. The communication interface 1130 may provide means for performing some of the blocks for one or more example embodiments described above. The communication interface 1130 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 1130 provides the apparatus with radio communication capabilities to communicate in the wireless communication network. The communication interface may, for example, provide a radio interface to one or more wireless communication devices. The apparatus 1100 may further comprise or be connected to another interface towards a core network such as the network coordinator apparatus or AMF, and/or to the access nodes of the wireless communication network.

The apparatus 1100 may further comprise a scheduler 1140 that is configured to allocate radio resources. The scheduler 1140 may be configured along with the communication control circuitry 1110 or it may be separately configured.

It is to be noted that the apparatus 1100 may further comprise various components not illustrated in FIG. 11. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways within the scope of the claims. The embodiments are not limited to the example embodiments described above, but may vary within the scope of the claims. Therefore, all words and expressions should be interpreted broadly, and they are intended to illustrate, not to restrict, the embodiments.

1.-19. (canceled)

20. An apparatus comprising:
at least one processor; and
at least one memory storing instructions that, when executed by the at least one processor, cause the apparatus at least to:
log information related to a radio resource management relaxation state of the apparatus wherein the information comprises: a time of entering the radio resource management relaxation state, a time of exiting the radio resource management relaxation state, a duration of the radio resource management relaxation state, at least one trigger that caused entering the radio resource management relaxation state, an identity of a serving cell on which one or more radio resource management relaxation parameters used for evaluating the at least one trigger were obtained, and the one or more radio resource management relaxation parameters used for evaluating the at least one trigger;
generate a message comprising the information, wherein the message is generated based on the amount of energy saved being below a first threshold, the duration of the radio resource management relaxation state being below a second threshold, and a failure, the failure comprising one of: a radio resource control connection establishment failure or a paging failure, wherein the message further comprises: one or more radio measurements of the serving cell that were obtained before entering the radio resource management relaxation state in the serving cell, one or more radio measurements of one or more neighboring cells that were obtained before entering the radio resource management relaxation state in the serving cell, and information related to a connection establishment failure in the serving cell;
transmit the message;
perform a cell re-selection procedure to re-select to a neighboring cell controlled by a target network node as a new serving cell, the cell re-selection procedure based on new measurements of the serving cell and the one or more neighboring cells;
disable a radio resource management relaxation function based on re-selecting the same serving cell within a pre-defined time limit after the failure in the serving cell; and
exit the radio resource management relaxation state based on re-selecting the serving cell within the pre-defined time limit after the failure in the serving cell, wherein the message further comprises an indication indicating the disabling of the radio resource management relaxation function;
perform a second cell re-selection procedure to re-select to a second neighboring cell controlled by the target network node;
transmit a setup request message to the target network node controlling the second neighboring cell; and
transmit an information response message to the target network node, wherein the information response message comprises a connection establishment failure report message comprising a relaxation report to enable an adjustment or optimization, based at least partly on the information in the relaxation report, one or more radio resource management relaxation parameters associated with triggering the radio resource management relaxation state.

21. The apparatus of claim 20, wherein the information is logged based on entering the radio resource management relaxation state.

22. The apparatus of claim 20, wherein the information is logged based on exiting the radio resource management relaxation state.

23. The apparatus of claim 22, wherein the message is transmitted based at least on performing the cell re-selection.

24. The apparatus of claim 23, wherein the message further comprises an indication indicating whether a paging message was received within a pre-defined time duration before setting up a connection.

25. The apparatus of claim 23, wherein the message further comprises an indication indicating whether a paging message was received before exiting the radio resource management relaxation state.

26. The apparatus of claim 25, wherein the message further comprises information indicating an amount of energy saved in the radio resource management relaxation state.

27. A system comprising:
an apparatus;
at least one processor; and
at least one memory storing instructions that, when executed by the at least one processor, cause the apparatus at least to:
log information related to a radio resource management relaxation state of the apparatus wherein the information comprises: a time of entering the radio resource management relaxation state, a time of exiting the radio resource management relaxation state, a duration of the radio resource management relaxation state, at least one trigger that caused entering the radio resource management relaxation state, an identity of a serving cell on which one or more radio resource management relaxation parameters used for evaluating the at least one trigger were obtained, and the one or more radio resource management relaxation parameters used for evaluating the at least one trigger;
generate a message comprising the information, wherein the message is generated based on the amount of energy saved being below a first threshold, the duration of the radio resource management relaxation state being below a second threshold, and a failure, the failure comprising one of: a radio resource control connection establishment failure or a paging failure, wherein the message further comprises: one or more radio measurements of the serving cell that were obtained before entering the radio resource management relaxation state in the serving cell, one or more radio measurements of one or more neighboring cells that were obtained before entering the radio resource management relaxation state in the serving cell, and information related to a connection establishment failure in the serving cell;
transmit the message;
perform a cell re-selection procedure to re-select to a neighboring cell controlled by a target network node as a new serving cell, the cell re-selection procedure based on new measurements of the serving cell and the one or more neighboring cells;
disable a radio resource management relaxation function based on re-selecting the same serving cell within a pre-defined time limit after the failure in the serving cell; and
exit the radio resource management relaxation state based on re-selecting the serving cell within the pre-defined time limit after the failure in the serving cell, wherein the message further comprises an indication indicating the disabling of the radio resource management relaxation function;
perform a second cell re-selection procedure to re-select to a second neighboring cell controlled by the target network node;
transmit a setup request message to the target network node controlling the second neighboring cell; and
transmit an information response message to the target network node, wherein the information response message comprises a connection establishment failure report message comprising a relaxation report to enable an adjustment or optimization, based at least partly on the information in the relaxation report, one or more radio resource management relaxation parameters associated with triggering the radio resource management relaxation state.

28. The system of claim 27, wherein the information is logged based on entering the radio resource management relaxation state.

29. The system of claim 27, wherein the information is logged based on exiting the radio resource management relaxation state.

30. The system of claim 29, wherein the message is transmitted based at least on performing the cell re-selection.

31. The system of claim 30, wherein the message further comprises an indication indicating whether a paging message was received within a pre-defined time duration before setting up a connection.

32. The system of claim 30, wherein the message further comprises an indication indicating whether a paging message was received before exiting the radio resource management relaxation state.

33. The system of claim 32, wherein the message further comprises information indicating an amount of energy saved in the radio resource management relaxation state.

34. A method comprising:
logging information related to a radio resource management relaxation state of the apparatus wherein the information comprises: a time of entering the radio resource management relaxation state, a time of exiting the radio resource management relaxation state, a duration of the radio resource management relaxation state, at least one trigger that caused entering the radio resource management relaxation state, an identity of a serving cell on which one or more radio resource management relaxation parameters used for evaluating the at least one trigger were obtained, and the one or more radio resource management relaxation parameters used for evaluating the at least one trigger;
generating a message comprising the information, wherein the message is generated based on the amount of energy saved being below a first threshold, the duration of the radio resource management relaxation state being below a second threshold, and a failure, the failure comprising one of: a radio resource control connection establishment failure or a paging failure, wherein the message further comprises: one or more radio measurements of the serving cell that were obtained before entering the radio resource management relaxation state in the serving cell, one or more radio measurements of one or more neighboring cells that were obtained before entering the radio resource management relaxation state in the serving cell, and information related to a connection establishment failure in the serving cell;
transmitting the message;
performing a cell re-selection procedure to re-select to a neighboring cell controlled by a target network node as a new serving cell, the cell re-selection procedure based on new measurements of the serving cell and the one or more neighboring cells;
disabling a radio resource management relaxation function based on re-selecting the same serving cell within a pre-defined time limit after the failure in the serving cell; and
exiting the radio resource management relaxation state based on re-selecting the serving cell within the pre-defined time limit after the failure in the serving cell, wherein the message further comprises an indication indicating the disabling of the radio resource management relaxation function;
performing a second cell re-selection procedure to re-select to a second neighboring cell controlled by the target network node;
transmitting a setup request message to the target network node controlling the second neighboring cell; and
transmitting an information response message to the target network node, wherein the information response message comprises a connection establishment failure report message comprising a relaxation report to enable an adjustment or optimization, based at least partly on the information in the relaxation report, one or more radio resource management relaxation parameters associated with triggering the radio resource management relaxation state.

35. The method of claim 34, wherein the information is logged based on entering the radio resource management relaxation state.

36. The method of claim 34, wherein the information is logged based on exiting the radio resource management relaxation state.

37. The method of claim 36, wherein the message is transmitted based at least on performing the cell re-selection.

38. The method of claim 37, wherein the message further comprises an indication indicating whether a paging message was received within a pre-defined time duration before setting up a connection.

39. The method of claim 37, wherein the message further comprises an indication indicating whether a paging message was received before exiting the radio resource management relaxation state, and wherein the message further comprises information indicating an amount of energy saved in the radio resource management relaxation state.
